(19) United States
(12) Patent Application Publication
(10) Pub. No.: US 2020/0238855 A1
(43) Pub. Date: Jul. 30, 2020

(54) VEHICLE WITH AN OCCUPANT PROTECTION SYSTEM WITH AN ENLARGED FREE SPACE AVAILABLE IN THE VEHICLE INTERIOR

(71) Applicant: VOLKSWAGEN AKTIENGESELLSCHAFT, Wolfsburg (DE)

(72) Inventors: Eduard SEIB, Wolfsburg (DE); Thorsten OKUPNIK, Salzgitter (DE); Juergen CORDES, Braunschweig (DE); Jens MESCHKE, Vordorf (DE); Martin SCHMUECKER, Braunschweig (DE); Thomas WOHLLEBE, Calberlah (DE); Manuel KURZ, Cremlingen (DE); Thomas DRESCHER, Gifhorn (DE)

(73) Assignee: VOLKSWAGEN AKTIENGESELLSCHAFT, Wolfsburg (DE)

(21) Appl. No.: 16/845,948

(22) Filed: Apr. 10, 2020

Related U.S. Application Data
(63) Continuation of application No. PCT/EP2018/077629, filed on Oct. 10, 2018.

(30) Foreign Application Priority Data
Oct. 10, 2017 (DE) 10 2017 218 024.2

(51) Int. Cl. B60N 2/02; B60R 21/0134; B60R 21/0132; B60R 21/015; B60N 2/427; B60R 22/26; B60N 2/888; B60R 22/46

(52) U.S. Cl. CPC B60N 2/0276; B60R 21/0134; B60R 21/0132; B60R 21/01554; B60N 2/4279; B60R 2021/0004; B60R 22/26; B60N 2/888; B60R 22/4628; B60R 21/01516; B60N 2/42709

(57) ABSTRACT

A vehicle with a vehicle seat arranged in the vehicle interior, which is paired with an occupant protection system, which has at least one crash detection sensor system that detects at least one acceleration value in the event of a crash, which influences the vehicle in the event of a crash so that inertial forces act on the vehicle seat connected to the vehicle and on the occupant sitting on the vehicle seat on the basis of an acceleration value, wherein the acceleration value is used for the crash-adaptive specification, over time, of said displacement travel of the occupant secured with a belt system on the vehicle seat. A total displacement travel of the vehicle seat in the travel direction comprises an additional, exclusively crash-active displacement travel adjoining a displacement travel of the vehicle seat for seat length adjustment in the travel direction.

This nonprovisional application is a continuation of International Application No. PCT/EP2018/077629, which was filed on Oct. 10, 2018, and which claims priority to German Patent Application No. 10 2017 218 024.2, which was filed in Germany on Oct. 10, 2017, and which are both herein incorporated by reference

### BACKGROUND OF THE INVENTION

### Field of the Invention

The present invention relates to a vehicle with a vehicle seat arranged in the vehicle interior, which is paired with an occupant protection system that has at least one crash detection sensor system, which detects at least one acceleration value in the event of a crash, wherein the latter has an influence on the vehicle in the event of a crash such that inertial forces act on the vehicle seat connected to the vehicle and on the occupant sitting on the vehicle seat on the basis of the detected acceleration value, wherein the acceleration value is used for a crash-adaptive specification of a displacement travel of the occupant secured to the vehicle seat by a belt system over time, said displacement travel absorbing the inertial forces.

### Description of the Background Art

The publication DE 198 20 214 A1 describes a method for reducing the severity of injuries to motor vehicle occupants in an accident. In the event of strong vehicle deceleration or vehicle acceleration, the occupants move a limited distance relative to the vehicle counter the force of a damping device. As a result of the fact that the occupants can move or shift a limited distance with damping of the relative movement in the event of strong vehicle deceleration, an additional braking distance is obtained, which enables a more uniform or weaker braking, reducing the risk of injury. Any existing airbag can be inflated “more softly” or does not have to be put into operation at all. Furthermore, it is stated that the driver's seat is fastened to the vehicle by means of a fastening device which enables the vehicle seat to be displaced to a limited extent relative to the chassis, the displacement taking place counter the force of a damping device. The driver's seat, which can be displaced relative to the vehicle counter the force of a damping device, can be attached directly to a vehicle frame or chassis or within a rigid passenger compartment, which in turn is movable relative to the frame.

The publication EP 2 546 097 A1 discloses a length adjustment of the seat or seat shift caused by a crash. The crash drive uses a linearly displaceable vehicle seat rail arranged on a vehicle floor, so that a defined displacement of the entire vehicle seat can take place in the event of a crash, which provides better protection against injuries owing to the so-called whiplash effect.

The publication DE 60 2005 001 224 T2, which corresponds to U.S. Pat. No. 7,568,544, describes an occupant protection device for a vehicle. The occupant protection device comprises a main control unit as a controller, which contains a microcomputer and a logic circuit, and an impact early warning unit in terms of an impact prediction device, which is configured with a millimeter-wave radar and contains at least one operating unit.

The impact early warning unit is used to anticipate or predict a possibility of, or otherwise a vehicle impact based on mileage related to a target ahead and vehicle speed related to a target ahead. The operating units are configured as an operating unit for operating a sliding roof device, as an operating unit for operating a side window device, as an operating unit for operating a seat backrest adjustment device, as an operating unit for operating a seat displacement device, as an operating unit for operating a seat height adjustment device, as an operating unit for operating a pre-crash seat belt. Via a communication bus, each operating unit receives information about a vehicle crash that was foreseen by the impact early warning unit. A control circuit of the occupant protection device is configured such that the operating units are operated in such a way that each of the devices is brought into a state that is suitable for protecting the vehicle occupants. In other words, the intention is to carry out various actions prior to a collision in order to protect the occupant. Among other measures, basically, the seat settings are changed, that is, the backrest is adjusted, for example, and/or the vehicle seat as a whole is shifted linearly.

### SUMMARY OF THE INVENTION

It is therefore an object of the present invention to provide an occupant protection system for a vehicle with which it is possible to largely reduce the injuries to the occupant in the event of an accident, wherein the biomechanical stress values acting on the occupant in the accident are to be minimized.

In an exemplary embodiment, a vehicle is provided with a vehicle seat arranged in the vehicle interior, which is paired with an occupant protection system that has at least one crash detection sensor system, which detects at least one acceleration value in the event of a crash, wherein the latter has an influence on the vehicle in the event of a crash such that inertial forces act on the vehicle seat connected to the vehicle and on the occupant sitting on the vehicle seat on the basis of the detected acceleration value, wherein the acceleration value is used for a crash-adaptive specification of a displacement travel of the occupant secured to the vehicle seat by a belt system, over time, said displacement travel absorbing the inertial forces.

A total displacement travel of the vehicle seat in the travel direction can comprise an additional, exclusively crash-active displacement travel which follows a displacement travel of the vehicle seat in the travel direction in order to longitudinally adjust the seat, wherein said additional exclusively crash-active displacement travel is produced by an enlargement of the free space available in the vehicle interior in front of the vehicle seat in the travel direction.

The advantage is that in the event of a crash, the vehicle seat can be moved further forward than before, whereby within the increased displacement travel per unit of time a force absorption can be achieved through the seat connection of the vehicle seat, which represents less stress for the person sitting on the vehicle seat. The forces transferred to the person (the occupant) through the belt system can be reduced, since increased displacement travel is available for absorbing the force. Not only can the forces transferred to the person be limited in order to avoid too much stress, but the stress limit can also be observed since the forces can be distributed over an increased displacement travel per unit of time in such a way that the stress limit is not even reached.

The enlargement of the additional free space available in front of the vehicle seat in the travel direction can be achieved by eliminating a front crash airbag system in the dashboard of the vehicle that is reduced counter the travel direction. This solution results from a basic idea which includes the fact that in future, the autonomous driving of vehicles will result in a changed seating position for the occupants.

It is possible for the occupants, in particular in the front row of seats, to be in a position in which the occupants sitting on a vehicle seat are arranged rotated relative to the occupants of the rear row of seats by unlocking, swiveling and locking of the vehicle seat. In other words, the back of the occupants sitting in the front row of seats faces the dashboard. Consequently, conventional airbag systems lose the role geared towards their previous application. It is therefore necessary to develop occupant protection systems that can do without conventional airbag systems. This elimination advantageously results in additional free space being available in the front area of the dashboard, which the occupant protection system described in this patent application makes use of.

The vehicle preferably has, at least in the front, crash-active structures that reduce the acceleration value. This measure advantageously ensures that the forces to be absorbed by the seat connection, which are generated by the crash, are reduced from the outset by the crash-active structures.

A free displacement travel available within the total displacement travel can be detected by at least one interior sensor system which detects the—truly—available free space between the front of the vehicle seat and the side of the dashboard facing the vehicle seat. Such an interior sensor system advantageously ensures that the occupant protection system is not based on a theoretically available maximum displacement travel, but that the actual free displacement travel really available at the time of the crash is used to control the occupant protection system.

The crash detection sensor system can predict an accident (pre-crash) occurring prior to the time of the crash and/or detects an accident taking place at the time of the crash, so that the vehicle seat with the sitting occupant is moved by a displacement travel provided for seat length adjustment and for crash-active displacement at a crash time occurring prior to the actual crash, counter the travel direction in order to increase the available total displacement travel in the travel direction beyond the already mentioned displacement travel by the further displacement travel. This approach has several advantages. The first advantage is that the crash detection sensor system of the vehicle can be used to predict a crash time in the future. The time between the prediction time and the crash time is advantageously used to shift the vehicle seat counter the travel direction. This shift can be carried out in an advantageous manner via the already existing seat length adjustment device, in particular a seat rail system. This seat length adjustment device is not crash-active in normal operation. Only at the time of the prediction is the seat length adjustment device switched to crash-active, so that the vehicle seat is moved counter the travel direction to further increase the total displacement travel in the travel direction.

It is also advantageously provided that the available free displacement travel within the total displacement travel, which is carried out prior to the crash time at the time of prediction counter the travel direction, is detected by at least one interior sensor system that detects the available free space between a rear of the vehicle seat and an object detected behind the vehicle seat. The advantage again is that the amount of backward displacement of the vehicle seat that is possible counter the travel direction is determined by the interior sensor system on the basis of the conditions that actually exist at the time of the prediction, in terms of the available free space.

In addition, the occupant protection system has a vehicle seat with a seat connection that comprises at least one force absorption component, which absorbs the inertial forces within the total displacement travel over time, as a result of which the vehicle seat with the seated occupant is braked within the total displacement travel with an optimized deceleration over time. A deformation element and/or a tension rod and/or a torsion rod, which is arranged between the vehicle seat and the chassis, is/are provided as at least one force absorption component. It is preferably provided that the at least one force absorption component is arranged within the seat rail or the seat structure.

Advantageously, according to the invention, the increased displacement travel of the vehicle seat in the travel direction that is available at the time of the crash, as compared to conventional vehicle seats that are immobile in the event of a crash, achieves the effect that inertial forces are absorbed over time by the at least one force absorption component within the increased displacement travel such that the biomechanical stress values influencing the occupant are reduced.

In addition, the effect is achieved that due to the crash-active displacement of the vehicle seat—in itself—via the total displacement travel or the total displacement travel of the vehicle seat in the travel direction, which is increased according to the invention, the biomechanical stress values influencing the occupant are also reduced by the crash-related change in the motion sequence of the occupant sitting on the vehicle seat.

In particular, the changed course of movement of the head and the changed course of movement of the legs or the relative movement of the head with respect to the legs of the occupant means that in the event of a crash, in particular due to the inventive increased total displacement travel of the vehicle seat in the travel direction, in particular in a vehicle without an airbag, there is no impact of the head on the thighs of the legs, whereby the biomechanical stress values influencing the occupant are reduced.

Thus, in the event of a crash, absorption of the inertial forces is achieved by means of the at least one force absorption component and by means of the displaceability of the vehicle seat; in particular, an overall effect combining the above-mentioned effects is achieved via the increased total displacement travel of the vehicle seat in the travel direction, which ensures, as explained in more detail in the description, in particular improved protection of the occupant in the vehicle, in particular in a vehicle without airbags.

It is also provided that the vehicle seat can have a seat connection which comprises at least one force output component, which emits forces over time within the total displacement travel, as a result of which the vehicle seat with the seated occupant is accelerated with an optimized acceleration within the total displacement travel over time. A pyrotechnic system and/or a spring system, for example, is/are provided as at least one force output component, which is/are arranged between the vehicle seat and the chassis. It is preferably provided that the at least one force output component is arranged within the seat rail or the seat structure.

In an advantageous manner, the at least one force absorption component can be compactly integrated into the seat connection, taking into account the crash forces that may occur, and it can also be provided that, if necessary, not only deceleration of the vehicle seat but also acceleration by the at least one force output component of the vehicle seat is realizable to prevent the occupant's head from pitching forward.

In this context, it is provided that forces can be absorbed via the at least one force absorption component, wherein in a preferred embodiment of the invention, the forces within the detected total displacement travel are absorbed over time on the basis of the detected acceleration value by specifying a force/displacement characteristic curve that is adapted over time to the acceleration value and the detected total displacement travel.

Advantageously, the acceleration value and the actually available total displacement travel are taken into account over time, whereby—depending on which value was detected for the acceleration value and which value is available for the total displacement travel—a corresponding force/displacement characteristic curve is chosen in order to absorb the forces within the seat connection via the force absorption component that is available.

The at least one force absorption component and/or force output component can be individually matched to the mass of the sitting occupant, which is detected by means of a weight detection sensor system assigned to the vehicle seat. In other words, there is preferably no static weight specification within the control of the occupant protection system, but instead the individual mass of the seated occupant is always taken into account in an advantageous manner.

In the vehicle interior, either a vehicle seat with an integrated belt system (seat with an integrated seat belt—first embodiment) is arranged, or a vehicle seat is arranged with a belt system (vehicle seat—second embodiment in two variants) that is attached to a B-pillar.

The advantage is that the occupant protection system described can be used both for integrated seats and for vehicle seats with belt systems attached to a B-pillar.

It is also proposed according to the invention that the respective vehicle seat comprises a catching mechanism for the legs of the occupant. This idea according to the invention is based on the idea that, unlike the upper body of the occupant, the legs are not fixed to the vehicle seat via the belt system. Especially in autonomous driving, the position of the occupant or the position of the vehicle seat with the occupant arranged thereon is uncertain, so that rotating movements of the occupant's legs can occur in the event of a crash. For the legs to lie snugly against the vehicle seat, analogous to the upper body, it is proposed to secure the legs with a loop on the vehicle seat side, in particular with a crash-active loop that closes in the event of a crash, which surrounds the legs, or to provide a Velcro fastener between the legs and the seat, so that in both embodiments a movement of the occupant's legs away from the vehicle seat is prevented.

In addition, it is also provided that a backrest part of the vehicle seat of the vehicle, in particular a swivel seat, has a head restraint which engages around the head of the occupant in a crash-active manner by means of head restraint side bolsters, so that the head of the occupant cannot be thrown when the seat is turned sideways in a crash, such as is explained in more detail in the description. It goes without saying that this head restraint configuration can also be used in a crash-active manner for a non-rotatable vehicle seat, since in the event of a crash, torsional movements of the head with respect to the torso of the occupant can also occur with non-rotatable vehicle seats.

The respective vehicle seat can include a catching mechanism for the arms and hands of the occupant, so that the body of the occupant (legs and arms) is held firmly against the vehicle seat by at least one belt system and corresponding catching mechanisms.

Finally, it is also provided according to the invention that a further interior sensor system can be arranged in the vehicle interior, which, by monitoring the occupant, determines when a rebound phase has been reached within the crash, so that at this point in time further displacement of the vehicle seat in the travel direction is prevented. This measure of a further interior sensor system ensures in an advantageous manner that a rebound phase is detected, so that a displacement of the vehicle seat in the travel direction at the time of such an event is not continued, whereby the inventive occupant protection system also advantageously takes into account such a rebound effect.

In general, reference is made to the fact that the above-described embodiment and procedure for seat displacement in a frontal crash, taking into account the displacement travel of the vehicle seat available in the travel direction and counter the travel direction in the vehicle interior, can also be used in the rear rows of seats, in particular the second and/or third row of seats, and so on.

For the purposes of the following description, the direction lying in the longitudinal direction of the vehicle shall be referred to as “x”. The direction in the horizontal plane of the vehicle transverse to the x direction is designated as “y” and the direction in the vertical plane of the vehicle transverse to the x direction is designate as “z”. This designation of the spatial directions in Cartesian coordinates corresponds to the coordinate system generally used in the motor vehicle industry. The same reference numbers are used below for the same components within all figures, wherein it is possible that not all of the components already presented are explained again in each figure on the basis of the reference numbers.

Below, the figures are used to explain occupant protection systems which eliminate arranging front crash airbag systems in the vehicle interior of a vehicle.

When the front crash airbag system is eliminated, reference is made to a vehicle with an airbag-less vehicle interior.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an occupant protection system with a belt system of a seat with an integrated belt;

FIG. 2 shows an occupant protection system with a belt system attached to a B-pillar, wherein the vehicle seat is arranged in front of the B-pillar;

FIG. 3 shows an occupant protection system with a belt system attached to the B-pillar, wherein the vehicle seat is arranged behind the B-pillar.

### DETAILED DESCRIPTION

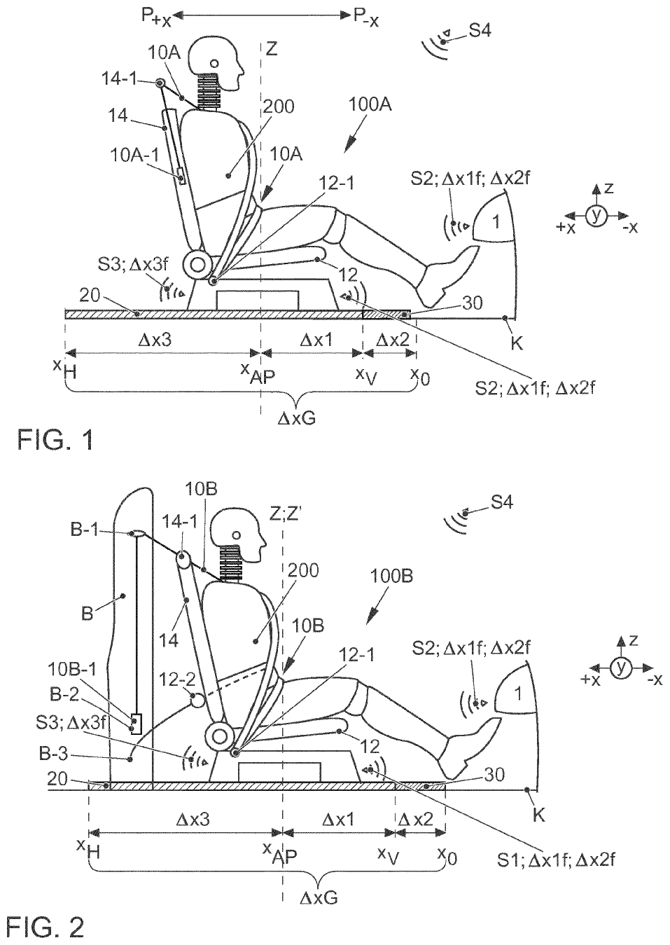

FIG. 1 shows a vehicle seat 100A as a seat with an integrated seat belt, which has a first belt system 10A for securing the occupant 200 on the seat with an integrated seat belt 100A. The belt system 10A has a belt buckle lock on the seat part side, a belt clamping tongue, a chest belt and a lap belt, as well as a belt retractor 10A-1, which as a rule comprises a belt tensioner and a belt force limiter.

Starting from a connection 12-1 on the seat part side in concert with the lap belt, the chest belt is guided by means of the belt buckle lock on the seat part 12 via a backrest-side deflector 14-1 of the backrest part 14 to the belt retractor 10A-1 in the backrest part 14, wherein the chest belt ends in the belt retractor 10A-1. On the opposite side of the connection 12-1 (not visible in FIG. 1), the end of the lap belt of the seat with an integrated seat belt 100A is firmly connected to the seat part 12.

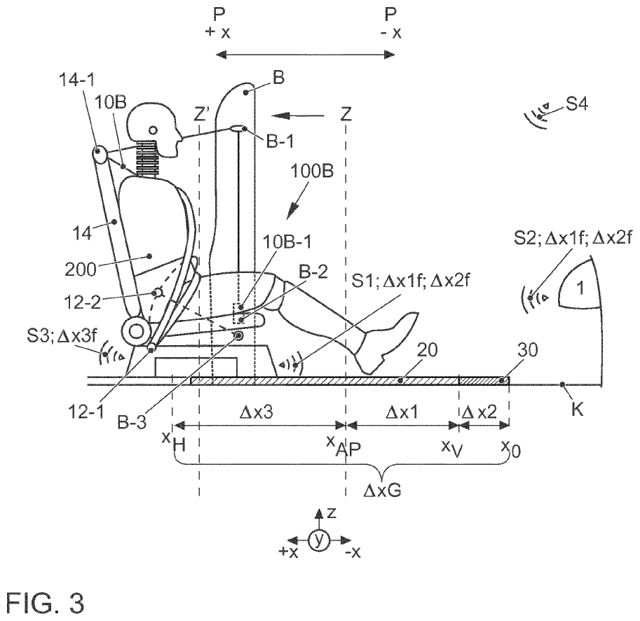

FIGS. 2 and 3 show a vehicle seat 100B that has a second belt system 10B for securing the occupant, which is fastened on the one hand to the B-pillar and on the other hand to the vehicle seat 100B.

The second belt system 10B can be designed in two embodiment variants, wherein a first embodiment variant is shown in FIGS. 2 and 3.

Second embodiment in a first embodiment variant (shown in FIGS. 2 and 3):

The second belt system 10B also comprises a seat part-side belt buckle lock, a belt clamping tongue, a chest belt and a lap belt, and a belt retractor, which as a rule comprises a belt tensioner and a belt force limiter.

Starting from a connection 12-1 to the seat part 12 on the seat part-side in concert with the lap belt, the chest belt is attached via a backrest-side deflector 14-1 and via a further deflector B-1 to the B-pillar at an attachment point on the B-pillar B provided for this purpose, wherein the chest belt is guided along the B-pillar B to a belt retractor 10B-1, which is attached to the B-pillar at an attachment point B-2, the chest belt ending at the attachment point B-2.

The end of the lap belt is attached to the B-pillar B at a further attachment point B-3 and is deflected at the seat part 12 by means of a seat part-side deflector 12-2 arranged on the opposite side of the seat part 12 and is guided to the connection 12-1 on the seat part-side shared with the chest belt, in particular for belt buckle locking of the seat part 12, wherein the lap belt and chest belt are releasably locked together in the belt buckle lock.

Second embodiment in a second embodiment variant (not shown):

In the other, second embodiment variant, not shown, the lap belt is not guided to the B-pillar B, but the end of the lap belt is fixedly connected to the seat part 12, analogous to a seat with an integrated seat belt (see FIG. 1) on the opposite side of the connection 12-1 (not shown in FIG. 2). The attachment point B-3 on the B-pillar B is therefore eliminated in this second embodiment variant.

In most embodiments and the described embodiment variants with the belt tensioner of the belt retractor 10A-1, 10B-1, the belt strap of the chest strap is mostly rolled up by a spring force and, counter the retraction force, a partial length of the belt strap of the chest strap is released so that overall, the length of the chest and lap belts lies tightly against the body of the seated occupant 200 in a known manner.

When the vehicle seat is shifted in the −/+x direction, the belt tensioner always ensures that no belt slack occurs, that is, the occupant 200 is always held tight in the belts against the vehicle seat 100A, 100B, in particular against the seat part 12 and against the backrest part 14.

The following explanations relate to a seat with an integrated seat belt 100A according to FIG. 1 and a vehicle seat 100B according to FIG. 2.

The starting point of the invention is a vehicle with sensors for automated driving and crash detection sensors, with which a crash can be predicted and detected.

A vehicle, not shown in more detail, has sensor systems, a first sensor system enabling automated driving and a second sensor system being able to predict and detect crash or accident situations.

The second sensor system makes it possible to control crash-active structures arranged in the front area of the vehicle, wherein, for example, an inflatable side rail and/or at least one extendable side rail and/or at least one extendable bumper and/or at least one inflatable bumper can be used as crash-active structures, which in the event of a crash are matched to the occupant load and generate an optimal deceleration pulse for the vehicle and thus also for the occupant.

Depending on the severity of the crash, the deceleration for the occupant 200 within the vehicle interior can be optimized by an occupant protection system beyond the optimal deceleration pulse for the vehicle as a whole, as will be explained further below.

According to the invention, it is provided that the vehicle interior does not contain a frontal crash airbag system.

According to FIG. 1, the occupant protection system for an occupant 200 sitting on a vehicle seat relates to an occupant protection system for the occupant 200, who is sitting on the seat with an integrated seat belt 100A, who is buckled in by means of a belt system 10A (first embodiment), or to an occupant protection system for the occupant 200, who is sitting on a vehicle seat 100B according to FIGS. 2 and 3 and is buckled in by means of the belt system 10B (second embodiment).

According to the invention, it is provided in each of the occupant protection systems that the vehicle seat 100A, 100B shifts forward in the −x direction in the event of a crash.

The maximum available path of the vehicle seat 100A, 100B, which can be moved forward in the −x direction in the event of a crash, is increased by eliminating the front crash airbag system in the front instrument panel 1 in the vehicle, as compared to conventional vehicles.

According to the invention, the frontal crash airbag system and the support structures belonging to the frontal crash airbag system are eliminated. It is provided that the dashboard 1 in the vehicle interior is smaller in the +x direction than before. Due to the elimination of the airbag system and the associated support structures, the panel cross member can also be reduced in size or even eliminated entirely, which, in addition to the elimination of the front crash airbag system and the associated support structures, also creates additional space which is available for the vehicle seat 100A, 100B to be moved to the maximum in the −x direction.

In other words (see FIGS. 1 to 3), the total displacement travel ΔxG for moving beyond the previously customary foremost position xV, starting from a rearmost position xH of the vehicle seat 100A, 100B in the vehicle interior, is greater in the inventive vehicle than in conventional vehicles, since according to the invention the vehicle seat 100A, 100B can be moved by an additional path Δx2 up to a foremost maximum position x0, as explained below.

To explain this, it is assumed that the vehicle seat 100A, 1006 is located at a so-called starting position xAP, which is located between the previously customary rearmost position xH and the foremost position xV in relation to a vertical central axis Z of the seat part 12 of the vehicle seat 100A, 100B, whereby a maximum displacement travel Δx1 can be realized to the front in the −x direction and a maximum displacement travel Δx3 can be realized to the rear in the +x direction.

Due to the elimination of the frontal crash airbag system and the associated support structures as well as the partial or complete elimination of the panel cross member, the available total displacement travel ΔxG between the starting position xAP and the foremost position xV is an additional path Δx2 greater than in conventional vehicles.

It is provided according to the invention that the seat connection acts like a force limiter when the vehicle seat 100A, 100B is displaced in the −x direction.

It is provided that the vehicle seat 100A, 1006, in particular the vehicle front seat, is displaceably connected to the chassis K. The displacement takes place, for example, via a seat rail system 20, the lower rail (s) of which is firmly connected to the chassis K, so that the upper rail (s) connected to the vehicle seat 100 can be reversibly displaced in the +/−x direction relative to the lower rail (s).

The seat rail system 20 permits, as explained, a displacement with a maximum body-mounted displacement travel Δx1 of the vehicle seat 100 to the front in the −x direction in the event of a crash according to a first embodiment.

In a second embodiment, it is provided that the vehicle seat 100A, 100B is moved in the extension of the seat rail system 20 extending in the x direction.

Various options are available for shifting the vehicle seat 100A, 100B further in the −x direction.

An additional travel length adjuster can be paired with the seat rail system 20 of the vehicle seat 100A, 1006, which is released in the event of a crash, when the displacement travel by Δx2 is to be available. The crash-dependent release is also referred to as exclusively crash-active.

The vehicle seat 100A, 100B can, for example, also be disengaged from the seat rail system 20 and displaced in a guide device 30 by the additional displacement travel by the maximum amount Δx2.

In any case, it is ensured that the vehicle seat 100A, 1006, guided after the corresponding release, can be moved by the additional displacement travel by the maximum amount Δx2.

In other words, the guide device 30 ensures that the vehicle seat 100A, 100B is moved forward by Δx2, beyond the previously possible maximum displacement travel Δx1 made possible by the seat rail system 20, and further up to the foremost maximum position x0 in the −x direction (as illustrated in FIGS. 1 to 3 by the respective arrow P-x).

The guided release of the vehicle seat 100A, 100B can provide a maximum additional value of the displacement travel of, for example Δx2=100 to 200 mm, which (see FIGS. 1 to 3), starting from the starting position xAP of the vehicle seat 100A, 1008, represents an extension of the maximum displacement travel Δx1 advantageously achieved by the corresponding measures.

The inertial force resulting from the weight of the vehicle seat 100 and the occupant 200 in the event of a crash can, according to the invention, be at least partially or completely absorbed via the displacement travel Δx1 or Δx1 plus Δx2. In other words, the inertial forces occurring at the time of the crash are absorbed as completely as possible or at least partially by the respective occupant protection system.

Functionally, a force limiter function is provided within the respective occupant protection system, which acts advantageously within the vehicle seat connection on the chassis K during the displacement travel Δx1 (first embodiment variant) and also within the vehicle seat guide during the displacement travel Δx2 (second embodiment variant).

Within the vehicle seat connection and/or the vehicle seat guide of the guide device 30, the vehicle seat 100A, 100B is provided with at least one force absorption component for absorbing the inertial forces.

This at least one force absorption component is able, on the one hand, to absorb the inertial forces occurring during the crash and, on the other hand, to release enough of the displacement travel in the −x direction (Δx1 or Δx1 plus Δx2) such that, depending on the accident situation, a kinematic change in the position of the vehicle seat 100 with the seated occupant 200 is made possible over time by an optimal, predefined displacement travel within the available displacement travel (Δx1 or Δx1 plus Δx2).

The force absorption component is a spring element or a damping element or a tension rod or a torsion spring or a deformation element or the like.

It is provided that in order to achieve optimal deceleration of the occupant 200 within the displacement travel (Δx1 or Δx1 plus Δx2), a force curve of the force absorption is predetermined over time. It is proposed to make the force curve of the force absorption switchable over time on the basis of characteristic curves, so that by switching the force curve of the force absorption within the at least one force absorption component, depending on the crash severity, an optimal deceleration characteristic curve is selected and the occupant 200 is optimally protected by the occupant protection system.

According to the invention, a first interior sensor system S1 (see figures) that senses the free space in the −x direction is provided, which is arranged on the front of the vehicle seat 100.

A second interior sensor system S2 (see figures) that senses the free space in the +x direction can also be arranged, which is disposed in the dashboard 1.

The interior sensor systems S1, S2 can be used in combination, so that redundant determination and monitoring of the possible displacement travel Δx1 or Δx1 plus Δx2 is possible.

At least one of the interior sensor systems S1, S2 determines the possible displacement travel Δx1 or Δx1 plus Δx2 in that, in the event of a crash, the free space for possible displacement of the vehicle seat 100A, 1006 in the vehicle interior between the front side of the dashboard 1 facing the occupant 200 and the front of a seat part 12 of the vehicle seat 100 closest to the dashboard 1 is determined.

In this case, it is provided that the displacement travel Δx1 or Δx1 plus Δx2 is chosen on the basis of the determined free space. If the maximized displacement travel Δx1 or Δx1 plus Δx2 is not usable in its entirety, because there is an object between the front of the dashboard 1 and the front of the vehicle seat 100, only the displacement travel Δx1f, Δx2f available within the maximum possible displacement travel Δx1 or Δx1 plus Δx2 is used, wherein it is provided that the force/displacement characteristic curve, and therefore the force/displacement characteristic curves of the defined displacement travel, are adjusted accordingly over time, in particular manually controlled.

It is provided that the vehicle seat 100A, 100B, as already explained, comprises a catching mechanism (not shown in more detail) for the legs and/or arms and hands of the occupant 200, so that at the moment when the vehicle seat 100A, 100B is moved forward in the −x direction, the legs and/or arms and hands of the occupant 20 are fixed in the respective catching mechanism against the vehicle seat 100A, 100B and as a result cannot be bent or pinched.

It is provided that the vehicle seat 100A, 100B can also have a rotary function about its vertical central axis Z, so that the vehicle seat 100 is a swivel seat that can be rotated by 360°, in particular by 180°, so that the occupant sits in the vehicle counter the travel direction.

In the event of a crash, according to the invention, the swivel seat is locked in any rotational position, wherein it can assume any of the possible rotational positions because, unlike previously, no adverse effects from a triggering airbag of a front crash airbag system are to be expected, so that occupant protection is also ensured if the occupant occupies a seating position that deviates from the usual seating position.

Thus, for example, the driver and/or the front passenger seat can be arranged rotated by 180°. In the event of a rear-end crash, it is proposed that a rotated seat, in particular a vehicle seat 100A, 100B rotated by 180° as explained in the description, is displaced in the event of a rear-end crash in the longitudinal direction of the seat counter the usual travel direction +x, or displaced only in the usual travel direction −x (for which there is a correspondingly greater total displacement travel ΔxG than was available thus far due to the elimination of the dashboard in the interior of the vehicle) and only then is moved counter the travel direction +x.

It is also ensured that the respective swivel seat in the respective rotational position, within the vehicle seat connection to the chassis K, remains in a locked state during the displacement travel Δx1.

When the swivel seat is advanced within the vehicle seat guide of the guide device 30 relative to the chassis K along the displacement travel Δx2 in the arrow direction of the arrow P-x, it is also ensured that the swivel seat does not start to rotate.

The backrest part 14 of the swivel seat also has a head restraint (not shown in more detail) which engages around the head of the occupant 200 in a crash-active manner by means of head restraint side bolsters, so that the head of the occupant 200 cannot be thrown when the seat is turned sideways in the event of a crash.

As previously stated, the vehicle has sensor systems, wherein the first sensor system enables automated driving and the second sensor system is able to predict and detect crash or accident situations.

An accident prior to the crash (pre-crash) and/or an accident occurring at the time of the crash can be sensed by means of the second sensor system.

In the sensed pre-crash event, the vehicle seat 100A, 100B according to the invention, starting from its position, for example, starting from its starting position xAP with the aid of an adjusting unit (not shown in detail), in particular a displacement motor, is displaced as far back as possible in the +x direction to the position xH in order to extend the displacement travel forward in the −x direction still further by a maximum of Δx3f, as shown by the arrow P+x.

In order to check whether there is sufficient free space behind the vehicle seat 100A, 1006, a further third interior sensor system S3, in particular a camera and/or a touch sensor, is arranged between the dashboard 1 and the front of the vehicle seat 100 in the rear of the vehicle seat 100A, 1006, analogously to the first and second interior sensor systems S1, S2, which determines the available free space by which the vehicle seat 100A, 1006 can be moved in the direction of the arrow P+x.

In this case, it is provided that the free displacement travel Δx3f of the maximum possible displacement travel Δx3 available between the respective position of the vehicle seat 100A, 100B up to the position xH is selected on the basis of the determined free space.

If, for example, the maximum displacement travel Δx3 between the starting position of the vehicle seat 100 and the rearmost position xH is not fully usable because, for example, there is an object between the rear of the vehicle seat 100 and the front of the object lying behind the vehicle seat in the +x direction, only the free displacement travel Δx3f available within the maximum displacement travel Δx3 is utilized, wherein it is provided to adjust, in particular manually control, the force/displacement ID and consequently the force/displacement characteristic curves of the defined displacement travel over time.

By monitoring the occupant 200, a still further fourth interior sensor system S4 determines when the rebound phase has been reached within the crash, so that at this point in time, further displacement of the vehicle seat 100A, 100B in the direction of the arrow P-x is prevented.

As already explained, FIGS. 2 and 3 show, in contrast to FIG. 1, a vehicle seat 100B with the second belt system 10B according to the second embodiment in the first embodiment variant in different positions.

The vehicle seat 100B according to FIGS. 2 and 3 is fastened to the B-pillar B by means of the second belt system 10B, in contrast to the seat with an integrated seat belt 100A, whereby according to the invention some technical details come into play.

According to the invention, in both embodiments and in the respective embodiment variants, it is provided that in a predicted or recognized crash, the belts of the first and second belt systems 10A, 10B are held tightly against the body of the occupant 200 in parallel to the displacement of the respective vehicle seat 100A, 100B in the +x direction by Δx3, at the latest at the detected time of the crash occurred, as follows.

In the predicted crash (pre-crash) or in the event of a crash, the belts of the first and second belt systems 10A, 10B in both embodiments and the respective embodiment variants are reversibly tightened and—as long as no crash occurs—again relieved by means of the belt tensioner of the respective belt retractor 10A-1, 10B-1 by a fast drive, in particular an electric motor. The associated electric motor drive is preferably integrated in the respective belt retractor 10A-1, 10B-1.

In the predicted crash event (pre-crash) or in the event of a crash, the belt is irreversibly tightened in both embodiments and in the respective embodiment variants by means of the belt tensioner of the respective belt retractor 10A-1, 10B-1 by a pyrotechnically designed belt tensioner of the retractor 10A-1, 10B-1. The associated pyrotechnic drive is preferably integrated in the respective belt retractor 10A-1, 10B-1.

In other words, the respective belt tensioner of the belt retractor 10A-1, 10B-1 of the belt systems 10A, 10B of both embodiments and of the respective embodiment variants has at least one reversible drive for belt tensioning and/or one irreversible drive for belt tensioning. The corresponding drive (s) is/are preferably integrated in the respective belt retractor 10A-1, 10B-1.

FIG. 2 shows the occupant protection system with a second belt system 10B attached to the B-pillar B (second embodiment) in the first embodiment variant, wherein the vehicle seat 100B is arranged in a position in front of the B-pillar, while the vehicle seat 100B according to FIG. 3 is arranged in a position behind the B-pillar according to the first embodiment variant.

If, as previously explained, the vehicle seat 100B, for example, starting from its starting position xAP according to FIG. 2 in the pre-crash with the aid of the adjustment unit, not shown in detail, in particular a displacement motor, is moved to the rear in the +x direction along the displacement travel Δx3 according to FIG. 3, as is illustrated by the arrow P+x, a displacement is guided rearward, behind the B-pillar B running in the vertical z direction, possibly to a so-called slack of the belt of the second belt system 10B.

As already explained, the total displacement travel ΔxG is extended by the displacement along the displacement travel Δx3. However, according to the invention, appropriate measures have been taken to ensure that there is no slack in the belt, so that the belt is always held sufficiently tight against the body of the occupant 200.

In the second belt system 10B, according to the invention, the backrest-side and seat part-side deflectors 14-1 and 12-2 are arranged as measures for tightening the belt (see FIGS. 2 and 3), which always hold the belt close to the body of the occupant 200 regardless of the position of the vehicle seat 100B.

If the vehicle seat 100B is moved behind the B-pillar B in the sensed pre-crash, the belt tensioning is automatic due to the displacement movement in the +x direction, so that a reversible pre-tensioning may not be necessary.

Depending on the distance of the vertical central axis Z′ (see FIG. 3) of the seat part 12 of the vehicle seat 100B from the vertical axis of the B-pillar B, the belt is released via the reversible drive during the pre-crash displacement movement in the +x direction, behind the B-pillar B (again see FIG. 3).

If the vehicle seat 100B is moved forward again in the sensed event of a crash, starting from the position behind the B-pillar B, the belt seat is automatically tensioned by the displacement movement of the vehicle seat 100B in the −x direction, but only once the vehicle seat 100B has passed the B-pillar B.

As a result, the belt is tensioned according to the invention by the conventional belt tensioner or additionally by the reversible (electromotive) belt tensioner and/or by the irreversible (pyrotechnic) belt tensioner when the vehicle seat 100B is displaced forward in the event of a crash, so that in no case—until the vehicle seat 100B has reached the B-pillar B—the belt loosens on the body of the occupant 200.

Depending on the distance between the vertical central axis Z′ of the seat part 12 of the vehicle seat 100B and the vertical axis of the B-pillar B, according to the invention, the belt of the second belt system 10B loosens via the reversible (electromotive) drive of the belt tensioner during the further displacement movement carried out in the event of a crash in the −x direction—past the B-pillar B—thus, in front of the B-pillar B (see FIG. 2=to the right of the B-pillar).

Depending on the severity of the crash, it is therefore possible to use the reversible (electromotive) belt tensioner, the irreversible (pyrotechnic) belt tensioner or a combination of the belt tensioners in order to secure the occupant 200. In the second belt system 10B, the belt is also released.

In a preferred embodiment, the irreversible (pyrotechnic) belt tensioner can be moved incrementally and triggered based on need, depending on the crash severity and/or the necessary tensioning of the belt.

The previous description also applies to the second embodiment variant of the second embodiment, since the only difference is that the lap belt is not guided to the attachment point B-3 on the pillar foot of the B-pillar B (see FIGS. 2 and 3), but instead the end of the lap belt is firmly connected to the seat part 12 on the opposite side of the connection 12-1 (not shown in FIG. 2), analogous to a seat with an integrated seat belt (see FIG. 1).

These measures for avoiding belt slack—when the vehicle seat 100A is shifted in the +x direction behind the B-pillar B of the vehicle—are only necessary for the two embodiment variants of the second embodiment, and therefore not necessary for a seat with an integrated seat belt 100A according to FIG. 1, because no belt slack is formed here since the seat system with an integrated belt 10A is not attached to the B-pillar B.

In the described embodiments and the respective embodiment variants, thus, optimal acceleration of the occupant 200 within the available displacement travel (Δx3 plus Δx1 or Δx3 plus Δx1 plus Δx2) can be achieved, taking into account a high level of safety for the occupant 200, wherein in turn a force curve of the force output is predetermined over time.

It is proposed here that the force curve of the force output also be switchable over time, so that depending on the crash conditions, optimum acceleration of the occupant 200 in the −x direction is achieved by the activated force curve of the force output in the forward direction.

In a preferred embodiment, it is provided that the vehicle seat 100 can also be accelerated forward in the −x direction. This acceleration in the −x direction can be brought about by a pyrotechnic system and/or a spring system as a force output component, which is arranged between the respective vehicle seat 100A, 100B and the chassis, so that the head of the occupant 200 is prevented from pitching forward.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vehicle comprising:
a vehicle seat arranged in a vehicle interior; and
an occupant protection system, the vehicle seat being paired with the occupant protection system that has at least one crash detection sensor system, which detects at least one acceleration value in the event of a crash and in the event of a crash influences the vehicle such that inertial forces act on the vehicle seat connected to the vehicle and on the occupant sitting on the vehicle seat on the basis of the detected acceleration value,
wherein the at least one acceleration value is used for the crash-adaptive specification of at least one displacement travel of the vehicle seat, over time, permitted by at least one force absorption component,
wherein a total displacement travel of the vehicle seat in the travel direction comprises an additional, exclusively crash-active displacement travel adjoining a displacement travel of the vehicle seat for adjusting the seat length in the travel direction, and
wherein the additional exclusively crash-active displacement travel is produced by an enlargement of a free space in the vehicle interior of the vehicle available in the travel direction in front of the vehicle seat.

2. The vehicle according to claim 1, wherein the enlargement of the free space additionally available in the travel direction in front of the vehicle seat is achieved due to the elimination of a front crash airbag system in a dashboard of the vehicle, which is reduced counter the driving direction.

3. The vehicle according to claim 1, wherein the vehicle comprises at least frontal crash-active, in particular extendable, adaptive structures which reduce the acceleration value.

4. The vehicle according to claim 1, wherein a free displacement travel available within the total displacement travel is detected by at least one interior sensor system, which detects the free space available between a front side of the vehicle seat and the dashboard facing the vehicle seat.

5. The vehicle according to claim 1, wherein the crash detection sensor system predicts an accident occurring prior to a crash time (pre-crash) and/or detects an accident occurring at the time of the crash, so that the vehicle seat with the seated occupant is displaced by a displacement travel intended for seat length adjustment and for crash-active displacement prior to the time of the crash counter the travel direction in order to further extend the total displacement travel available at the time of the crash in the travel direction beyond the displacement travel available along the displacement travel.

6. The vehicle according to claim 1, wherein the free displacement travel available within the total displacement travel, which is carried out prior to the time of the crash counter in the driving direction, is detected by at least one interior sensor system, which detects the available free space between a rear of the vehicle seat and an object behind the vehicle seat.

7. The vehicle according to claim 1, wherein the vehicle seat has a seat connection, which comprises at least one force absorption component, which absorbs the inertial forces within the total displacement travel over time, and wherein the vehicle seat with the seated occupant is decelerated within the total displacement travel, over time, with an optimized delay to reduce the biomechanical stress values.

8. The vehicle according to claim 1, wherein the vehicle seat has a seat connection comprising at least one force output component, which outputs forces over time within the total displacement travel, wherein the vehicle seat with the seated occupant is accelerated within the total displacement travel, over time, with an optimized acceleration.

9. The vehicle according to claim 4, wherein, via the at least one force absorption component, forces are absorbed, over time, within the detected total displacement travel in dependence of the detected acceleration value by setting a force/displacement characteristic curve that is adjusted, over time, to the acceleration value and the detected total displacement travel.

10. The vehicle according to claim 7, wherein the at least one force absorption component is a deformation element and/or a tension rod and/or a torsion rod and the at least one force absorption component is at least one pyrotechnic system and/or at least one spring system, wherein the at least one component is matched to the mass of the seated occupant, which is determined via a weight detection sensor system assigned to the vehicle seat.

11. The vehicle according to claim 1, wherein the vehicle seat is a seat with an integrated seat belt provided with an integrated belt system or a vehicle seat provided with a three-point belt system attached to a B-pillar.

12. The vehicle according to claim 1, wherein the vehicle seat comprise at least one crash-active catching mechanism for the legs and/or arms and/or hands of the occupant.

13. The vehicle according to claim 1, wherein a backrest part of the vehicle seat or of a swivel seat, has a headrest which surrounds the head of the occupant by means of headrest side bolsters in a crash-active manner.

14. The vehicle according to claim 10, wherein the belt system of the vehicle seat comprises a reversible, in particular electromotive belt tensioner and/or an irreversible, in particular pyrotechnic belt tensioner.

15. The vehicle according to claim 1, wherein, in the vehicle interior, an interior sensor system is arranged, which determines, by monitoring the occupant when a rebound phase is reached within the crash, so that at this time further displacement of the vehicle seat in the travel direction is prevented.
